(19) United States
(12) Patent Application Publication
(10) Pub. No.: US 2019/0213850 A1
(43) Pub. Date: Jul. 11, 2019

(54) Alert Shoe Having Smoke Generation Device

(71) Applicant: Tai Sheng Liu, Taichung City (TW)

(72) Inventor: Tai Sheng Liu, Taichung City (TW)

(21) Appl. No.: 15/865,390

(22) Filed: Jan. 9, 2018

(51) Int. Cl. G08B 5/40; B05B 17/06; B05B 12/02; A43B 3/00; A43B 7/06; A43B 13/14

(52) U.S. Cl. CPC G08B 5/40; B05B 17/0676; B05B 12/02; G06K 7/10366; A43B 7/06; A43B 13/14; A43B 3/0005

(57) ABSTRACT

An alert shoe includes a smoke generation device in a sole thereof. The smoke generation device includes an RFID tag; an upper casing; a complimentary lower casing releasably secured to the upper casing to form a space; supports on an inner surface of each of the upper and lower casings; a power source (e.g., rechargeable battery) in the space; a control unitin the space and electrically connected to the power source; a switch electrically connected to the control unit; a ventilation unit in the space and electrically connected to the control unit; and an atomizer in the space and electrically connected to the control unit. The atomizer may generate smoke to be expelled by the ventilation unit.

### BACKGROUND OF THE INVENTION

### 1. Field of the Invention

The invention relates to alert shoes and more particularly to an alert shoe having a smoke generation device adapted to generate color smoke for either alertness or entertainment.

### 2. Description of Related Art

A conventional alert shoe has either light reflection strips or an LED. However, there is no disclosure of an alert shoe having a smoke generation device as far as the present inventor is aware. Thus, alert function of the conventional alert shoe is poor. Further, there is no positioning device provided in the conventional alert shoe. Thus, it is very difficult of locating a person wears the alert shoe if the person gets lost. Furthermore, the sole of the conventional alert shoe is required to disassemble prior to replacing a discharged cell or recharging same. Disadvantageously, it is complicated and inconvenient and may damage the shoe.

Thus, the need for improvement still exists.

### SUMMARY OF THE INVENTION

It is therefore one object of the invention to provide an alert shoe including a smoke generation device in a sole thereof, the smoke generation device comprising an upper casing; a complimentary lower casing releasably secured to the upper casing to form a space; a plurality of supports provided on an inner surface of each of the upper casing and the lower casing; an RFID tag disposed on an outer surface of the smoke generation device; a power source for supplying electricity provided in the space; a control unit provided in the space and electrically connected to the power source; a switch projecting out of the outer surface of the smoke generation device and electrically connected to the control unit; a ventilation unit provided in the space and electrically connected to the control unit; and an atomizer provided in the space and electrically connected to the control unit; wherein the atomizer is configured to generate smoke to be expelled by the ventilation unit.

Preferably, there is further provided an electrical socket in the space and electrically connected to the power source, wherein the electrical socket is a USB receptacle, and wherein the power source is a rechargeable battery.

Preferably, there is further provided a sensor in the space.

Preferably, there is further provided a battery charge indicator on the outer surface of the smoke generation device, the battery charge indicator being electrically connected to the sensor which is electrically connected to the power source.

Preferably, the atomizer includes an inlet at an end, the inlet communicating with the outer surface of the smoke generation device so that fuel is configured to fill into the atomizer through the inlet, there is further provided a plug releasably disposed in the inlet.

Preferably, there is further provided an outlet on the outer surface of the smoke generation device, and a channel member in the outlet and projecting out of the smoke generation device.

Preferably, the control unit is a printed circuit board, the ventilation unit is a pump, and the atomizer is an electric atomizer or an ultrasonic atomizer.

The invention has the following advantages and benefits in comparison with the conventional art: it is easy to locate a wearer of the shoe if the wearer gets lost. The color smoke can be used for either alertness or entertainment.

The above and other objects, features and advantages of the invention will become apparent from the following detailed description taken with the accompanying drawings.

### BRIEF DESCRIPTION OF THE DRAWINGS

FIG. 1 is a perspective view of a smoke generation device according to a first preferred embodiment of the invention;

FIG. 2 is an exploded view of the smoke generation device;

FIG. 3 is a longitudinal sectional view of the smoke generation device showing its operation;

FIG. 4 is a block diagram of the smoke generation device;

FIG. 5 schematically shows the smoke generation device provided in a shoe and its operation; and

FIG. 6 schematically shows the smoke generation device provided in a shoe and its operation according to a second preferred embodiment of the invention.

### DETAILED DESCRIPTION OF THE INVENTION

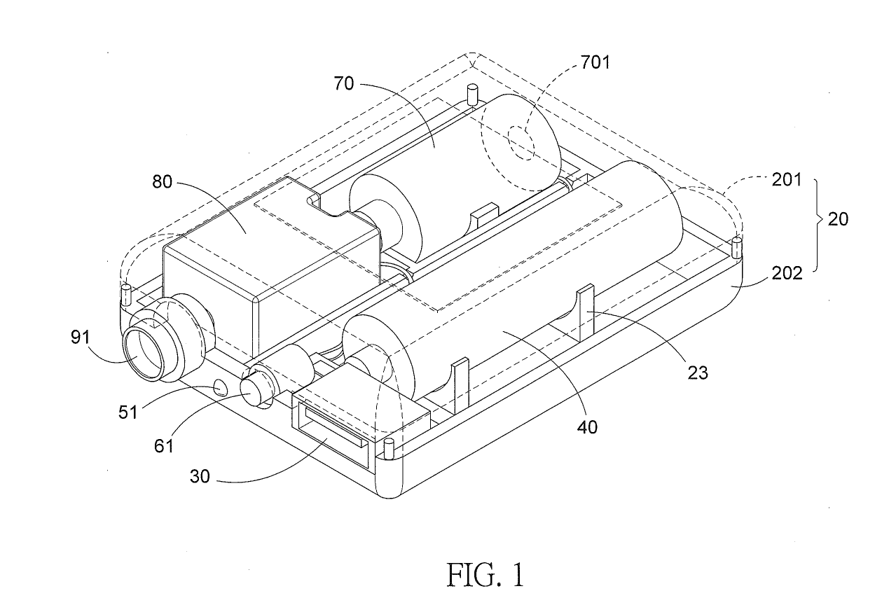

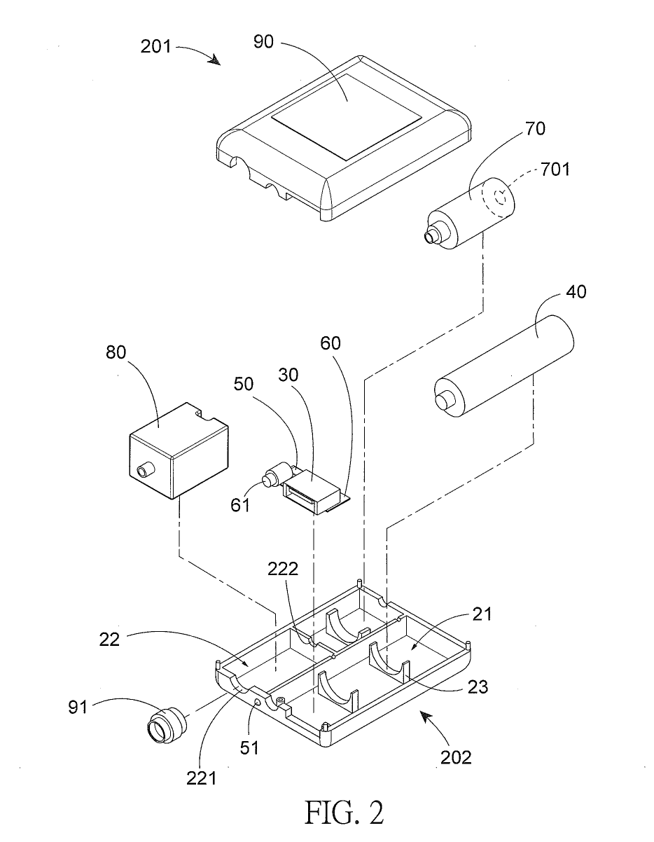

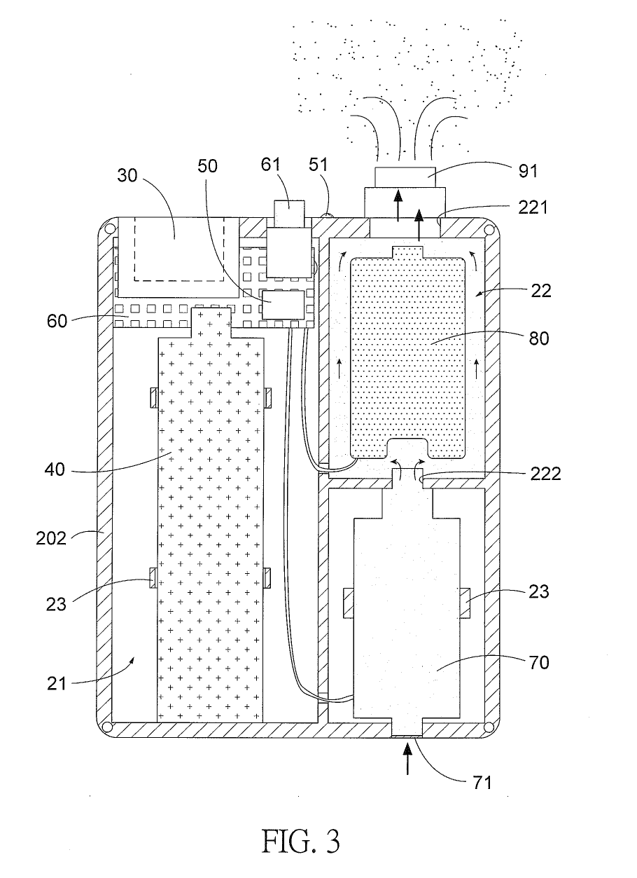

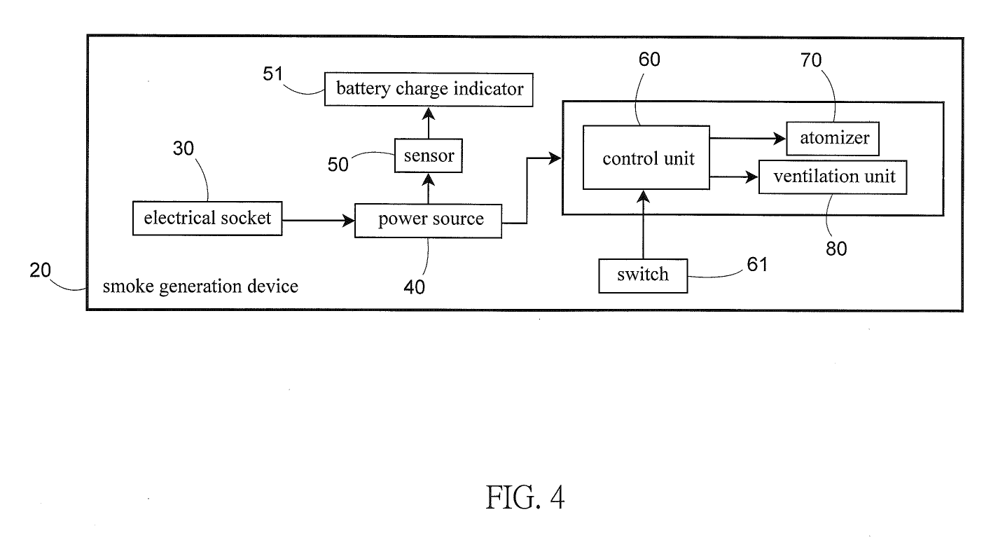

Referring to FIGS. 1 to 5, a smoke generation device 20 in accordance with the invention is shown. The smoke generation device 20 is disposed in a part of shoe 100 other than its sole 10. The smoke generation device 20 comprises the following components as discussed in detail below.

An upper casing 201 and a complementary lower casing 202 are made by injection molding. A plurality of supports 23 are provided on an inner surface of each of the upper casing 201 and the lower casing 202. A space 21 is defined by the upper casing 201 and the lower casing 202. A plurality of knurls (not shown) are provided on outer surfaces of the upper casing 201 and the lower casing 202. A power source (e.g., rechargeable cell) 40 is provided in the space 21 and electrically connected to an electrical socket (e.g., Universal Serial Bus (USB) receptacle) 30. The USB receptacle 30 complies with a direct current (DC) receptacle. A control unit (e.g., printed circuit board) 60 is provided in the space 21 and electrically connected to the power source 40. A manual switch 61 projects out of the smoke generation device 20 and is electrically connected to the control unit 60. The switch 61 is configured to press to activate the control unit 60 or deactivate the control unit 60. Alternatively, the switch 61 can be activated by a remote control.

As shown in FIGS. 1 to 3 specifically, a smoking compartment 22 is provided in the space 21 and includes an outlet 221 on the smoke generation device 20 communicating with the external. A replaceable channel member 91 is provided in the outlet 221 and projects out of the smoke generation device 20. A ventilation unit (e.g., pump) 80 is provided in the smoking compartment 22 and electrically connected to the control unit 60. A tunnel 222 is provided through an internal wall of the smoking compartment 22. An atomizer 70 is provided in the space 21 and adjacent to the smoking compartment 22. The atomizer 70 is electrically connected to the control unit 60 and communicates with the tunnel 222. The atomizer 70 includes an inlet 701 at an end and on the smoke generation device 20 so that external fuel can be filled into the atomizer 70 through the inlet 701. A plug 71 is releasably disposed in the inlet 701

A sensor 50 is provided in the space 21 and electrically connected to the power source 40. The sensor 50 is configured to measure the remaining battery capacity of the power source 40. A battery charge indicator 51 is provided on the smoke generation device 20 and electrically connected to the sensor 50. The battery charge indicator 51 may emit light of different colors to indicate the remaining battery capacity of the power source 40 when the smoke generation device 20 is in the standby state.

The atomizer (e.g., electric atomizer or ultrasonic atomizer) 70 has a knob (not shown) for adjusting output power. Fuel (e.g., glycerol) is filled in the atomizer 70. A person may select specific color and smell of glycerol so that the generated smoke may have the same color and smell.

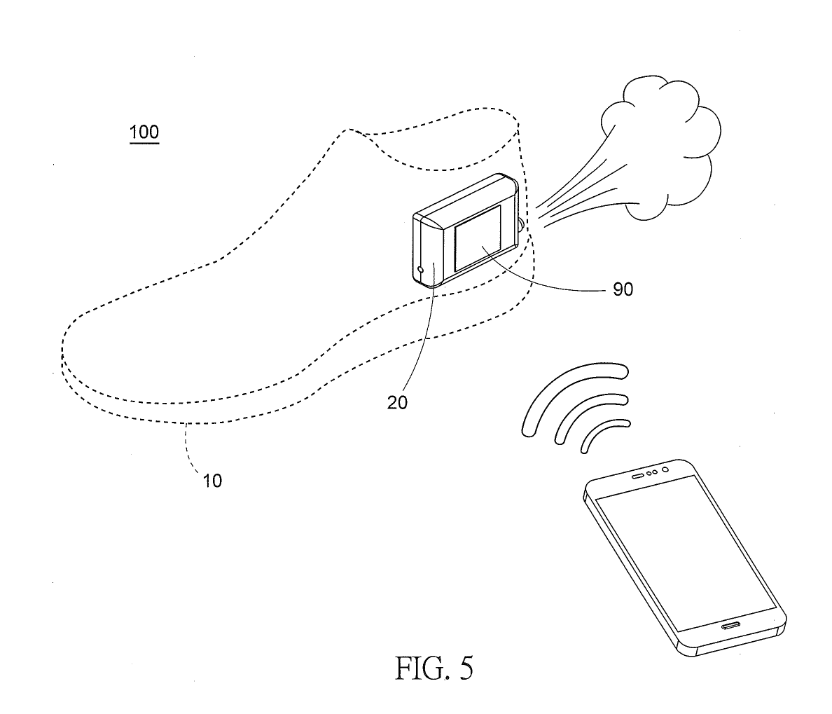

As shown in FIG. 5 specifically, a radio-frequency identification (RFID) tag 90 is provided on an outer surface of the smoke generation device 20. An RFID reader (not numbered) is provided to read information contained in the RFID tag 90.

Operations of the invention are described below. An individual (e.g., a deaf, an older person, or a partygoer) may attach the smoke generation device 20 to a part (e.g., the vamp or the side) of a shoe 100. Next, the individual may turn on the smoke generation device 20 by pressing the switch 61 (or by activating a remote control). Next, the power source 40 supplies power to the control unit 60, the atomizer 70 and the ventilation unit 80 respectively. The control unit 60 activates the atomizer 70 to heat the glycerol in the atomizer 70. As such, smoke is generated by the atomizer 70. The smoke then flows to the smoking compartment 22 through the tunnel 222. Also, the control unit 60 activates the ventilation unit 80 to move the smoke out of the smoke generation device 20 through the outlet 221. As a result, color smoke for either alertness or entertainment is generated.

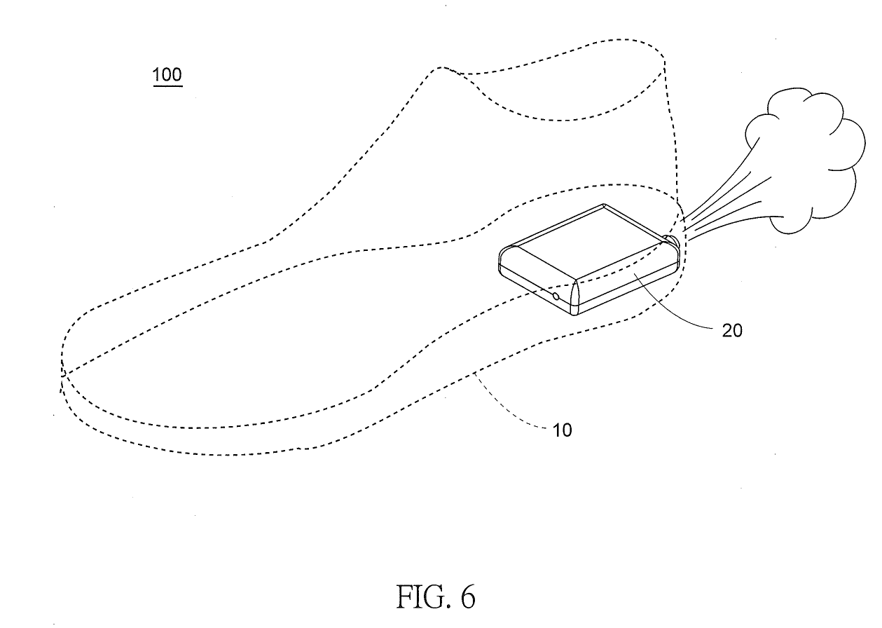

Referring to FIG. 6, an alert shoe 100 incorporating the smoke generation device 20 in accordance with a second preferred embodiment of the invention is shown. The characteristics of the second preferred embodiment are substantially the same as that of the first preferred embodiment except the following: the RFID tag is removed. The smoke generation device 20 is disposed in the sole 10 of the shoe 100.

The invention has the following characteristics and advantages: it is easy to locate a wearer of the shoe 100 if the wearer gets lost. The color smoke can be used for either alertness or entertainment.

While the invention has been described in terms of preferred embodiments, those skilled in the art will recognize that the invention can be practiced with modifications within the spirit and scope of the appended claims.

What is claimed is:

1. An alert shoe including a smoke generation device in a sole thereof, the smoke generation device comprising:
an upper casing;
a complimentary lower casing releasably secured to the upper casing to form a space;
a plurality of supports provided on an inner surface of each of the upper casing and the lower casing;
an RFID tag disposed on an outer surface of the smoke generation device;
a power source for supplying electricity provided in the space;
a control unit provided in the space and electrically connected to the power source;
a switch projecting out of the outer surface of the smoke generation device and electrically connected to the control unit;
a ventilation unit provided in the space and electrically connected to the control unit; and
an atomizer provided in the space and electrically connected to the control unit;
wherein the atomizer is configured to generate smoke to be expelled by the ventilation unit.

2. The alert shoe of claim 1, further comprising an electrical socket in the space and electrically connected to the power source, wherein the electrical socket is a USB receptacle, and wherein the power source is a rechargeable battery.

3. The alert shoe of claim 1, further comprising a sensor in the space.

4. The alert shoe of claim 3, further comprising a battery charge indicator on the outer surface of the smoke generation device, the battery charge indicator being electrically connected to the sensor which is electrically connected to the power source.

5. The alert shoe of claim 1, wherein the atomizer includes an inlet at an end, the inlet communicating with the outer surface of the smoke generation device so that fuel is configured to fill into the atomizer through the inlet, further comprising a plug releasably disposed in the inlet.

6. The alert shoe of claim 1, further comprising an outlet on the outer surface of the smoke generation device, and a channel member in the outlet and projecting out of the smoke generation device.

7. The alert shoe of claim 1, wherein the control unit is a printed circuit board, the ventilation unit is a pump, and the atomizer is an electric atomizer or an ultrasonic atomizer.
